(19) United States
(12) Patent Application Publication
(10) Pub. No.: US 2012/0046125 A1
(43) Pub. Date: Feb. 23, 2012

(54) GOLF BALLS CONTAINING VISIBLE DECORATIVE INSERTS PLACED BETWEEN TRANSPARENT LAYERS

(76) Inventors: Michael J. Sullivan, Barrington, RI (US); William E. Morgan, Barrington, RI (US)

(21) Appl. No.: 13/285,515

(22) Filed: Oct. 31, 2011

Related U.S. Application Data
(63) Continuation-in-part of application No. 12/143,879, filed on Jun. 23, 2008, now Pat. No. 8,070,626.
Application No. 12/143,879 is a continuation-in-part of application No. 11/707,493, filed on Feb. 16, 2007, now Pat. No. 7,722,483.

(51) Int. Cl. A63B 37/12; B32B 38/08; B32B 37/14; B32B 37/02; A63B 37/00; A63B 37/06

(52) U.S. Cl. 473/372; 473/371; 473/374; 156/280

(57) ABSTRACT

Golf balls containing a core having at least one layer; a composite layer comprising a first substantially transparent polymeric matrix; and a cover comprising a second substantially transparent polymeric matrix are provided. The ball contains at least one decorative insert member that can be seen through the layers. The decorative insert (for example, charm or jewelry piece) is sandwiched between the composite and cover layers. One portion of the insert is embedded in each layer. Light-reflective fillers, colored pigments, and dyes may be added to the layers to create different optical effects. The resulting ball has a unique and appealing appearance while maintaining its good playing properties.

### CROSS-REFERENCE TO RELATED APPLICATIONS

This application is a continuation-in-part of co-assigned U.S. patent application Ser. No. 12/143,879 filed Jun. 23, 2008, now allowed, which is a continuation-in-part of co-assigned U.S. patent application Ser. No. 11/707,493 filed Feb. 16, 2007, now U.S. Pat. No. 7,722,483, the entire disclosures of which are hereby incorporated by reference.

### BACKGROUND OF THE INVENTION

1. Field of the Invention

The present invention generally relates to multi-piece golf balls and more particularly to golf balls having substantially transparent layers. The ball contains a decorative insert member that can be seen through the layers. Reflective fillers, pigments, and dyes may be added to the layers to create different optical effects. The resulting ball has an aesthetically pleasing appearance and good playing performance properties.

2. Brief Review of the Related Art

Golf ball manufacturers are interested in assembling multi-piece solid golf balls today for various reasons including cost-effective manufacturing technologies, raw material prices, and demand. Both professional and amateur golfers enjoy playing with multi-piece sold golf balls because of their playing performance properties. Basically, a two-piece solid golf ball includes a solid inner core protected by an outer cover. The inner core is made commonly of a rubber material such as natural and synthetic rubbers: styrene butadiene, polybutadiene, or polyisoprene. Highly neutralized ethylene acid copolymer ionomer resins (HNPs) also may be used to form the core. The outer cover is made commonly of thermoplastic or thermoset resins such as ionomers, polyolefins, polyamides, polyesters, polyurethanes, and polyureas. As new materials and manufacturing processes have become more economically feasible, three-piece, four-piece, and five-piece solid golf balls have been introduced. Different materials are used in the golf ball construction to impart specific properties and playing features to the ball.

The cover may be formed around the golf ball sub-assembly by dispensing polymeric material into the mold cavities and mating them together under sufficient heat and pressure. By the term, “sub-assembly” as used herein, it is meant the inner ball, that is the core and any intermediate layer(s) disposed between the core and outer cover layer. For example, one technique involves using a white-pigmented material such as polyurethane, polyurea, or the like to form the cover as described above. The cover is surface-treated using a suitable method such as, for example, corona treatment, plasma treatment, UV treatment, flame treatment, or electron beam treatment. Trademarks, symbols, logos, letters, numerals, and other indicia may be printed on the ball's cover using pad-printing, ink-jet printing, dye sublimation, or other suitable printing methods. Then, clear surface coatings (for example, primer and top-coats), which may contain a fluorescent whitening agent, are applied to the cover. Suitable materials that can be used as such surface coatings include, for example, urethanes, urethane hybrids, epoxies, polyesters and acrylics. The resulting golf ball has a glossy and durable surface finish.

In another finishing process, the golf balls are painted with one or more paint coatings. For example, a primer paint may be applied first to the surface of the ball and then a white top-coat of paint may be applied over the primer. As noted above, markings such as trademarks and logos may be applied to the painted cover of the golf ball. Finally, a clear surface coating may be applied to the cover to provide a shiny finished appearance.

In recent years, there has been interest in manufacturing and playing with golf balls having different aesthetics than traditional white-colored balls. For example, Berard, U.S. Pat. No. 4,798,386 discloses golf balls having a cover with fluorescent appearance. The cover material may be clear, and the core may be white colored. The core may be stamped with a logo or trademark that is visible through the clear cover. According to the '386 patent, fluorescent dyes and pigments may be added to the cover composition to make the cover brighter.

Meyer, U.S. Pat. No. 4,998,734 discloses a ball having a core, an indicia-bearing liner, and a translucent or transparent cover. According to the '734 patent, the indicia-bearing liner is a thin layer of plastic or paper material, where upon textual, alphanumeric or graphic indicia can be printed thereon. The indicia-bearing liner is sufficiently thin to permit substantial transference of impact forces from the cover to the core without substantially reducing the transferred force.

Proudfit et al., U.S. Pat. No. 5,542,680 discloses a golf ball having a substantially clear cover so that the core of the ball is visible through the cover. The cover is preferably formed from a blend of ionomer resins. The core may be printed with indicia such as a logo or stripes which are visible through the clear cover. The core may include pigment or dye to provide color, or a white core can be produced using titanium dioxide.

Welch, U.S. Pat. No. 5,989,135 discloses a golf ball having a white core and a relatively thin, translucent cover made of ionomer resin. The translucent cover contains a photostorage material that stores radiant energy and re-emits a glow of light. A brightly-colored fluorescent dye can be added to the ionomer cover material to produce a golf ball that is brightly colored. For example, when a bright yellow fluorescent dye is used, the ball can be seen in daylight conditions. After the photostorage material is charged by exposure to light, the yellow fluorescent ball emits a bright glow for high visibility in the dark.

Yavitz, U.S. Pat. No. 6,012,992 discloses a golf ball having a cover formed from a clear ionomer resin, and a distinct second region formed from an opaque ionomer resin. Indicia such as a logo may be printed on the surface of the core so that is disposed beneath the first region 24. Because the first region of the cover is transparent, the indicia are visible from the exterior of the golf ball, and it is protected from wear and abrasion by the cover. The second region of the cover is opaque, for example, it may be colored to provide different visual effects.

Sullivan, U.S. Pat. No. 6,315,681 discloses a golf ball containing core, a first cover layer, and a second cover layer. There is a recessed region with a viewing window along the outer surface of the ball. The first cover layer includes a particulate weighting material such as heavy weight fillers or fibers, which are added to increase the moment of inertia or the ball. The viewing window in the recessed region is generally transparent and enables at least a portion of the particulate weighting material in the first cover layer to be seen from the outer surface of the ball.

Sullivan et al., U.S. Pat. No. 7,435,192 discloses a golf ball comprising: a non-spherical insert core; at least one surrounding core layer; and at least one cover layer. The non-spherical core insert (as shown in FIGS. 5-8), is viewable through one or more translucent layers. The '301 patent further discloses that the cover/core layers may contain reflective or optically active particulates such as pearlescent pigment.

Morgan et al., U.S. Pat. No. 7,722,483 discloses a golf ball comprising a core, a cover and at least one intermediate layer disposed between the core and cover. The intermediate layer includes pigment which contributes to the color of the ball. The cover is at least partially transparent such that the intermediate layer is at least partially visible. The intermediate layer preferably is formed from a composition containing thermoplastic elastomer and florescent dye or optical brightener. The cover preferably is formed from a substantially translucent composition comprising polyisocyanate.

Morgan et al., U.S. Pat. No. 7,901,301 discloses a golf ball having at least one core layer; at least one intermediate layer encasing the core layer(s); and at least one cover layer encasing the intermediate layer (s). The core, intermediate, and cover layers may be translucent so that the non-spherical insert is visible, and the layers may contain a visually enhancing means such as metallics, fluorescents, phosphorescents, luminescents, pearlescents, optical brighteners, edge-effect pigments, pigments, dyes and/or tinting agents. The intermediate layer has a non-uniform thickness, that is, its thickness varies around the core layer and throughout the ball. The non-uniform thickness is created by outer projections such as webs or ribs on the surface of the intermediate layer as shown in FIGS. 1 and 1A. The intermediate layer has a distinct geometric pattern which serves to orient the golf ball in space, thereby indicating alignment of the golf ball.

One drawback with producing golf balls having visible inserts is that it can be difficult to properly position the insert in a golf ball layer. The insert should be positioned so that it is plainly visible to the human eye. In some instances, it may be difficult to clearly see the insert if it is completely enclosed within a layer and there are additional layers surrounding the insert-containing layer. It can be difficult to see the detailed features of the insert, because of the various surrounding layers, which are filled often with additives. If the insert is used as the inner core, as described in the above patent references, then it must be over-molded with other materials to form the final core structure. The cover sub-assembly then must be molded over the core structure. Thus, in some instances, it can be difficult to see the insert (inner core), because light must be transmitted through multiple filled layers. Also, the resiliency and rebounding performance of the golf ball is based primarily on the core. Balls with a higher rebound velocity have a higher Coefficient of Restitution or “COR” value. Such balls rebound faster, retain more total energy when struck by a club, and have longer flight distance. It is important that an insert incorporated in the golf ball does not negatively affect the ball's playing performance properties.

In recent years, there has been demand for golf balls having unique aesthetics. The present invention provides golf balls containing one or more decorative insert members. The ball includes neighboring substantially transparent layers and the decorative insert is sandwiched between these layers. The underlying core layers may be opaque and the cover layers may be substantially transparent resulting in a golf ball having a distinct appearance along with other advantageous properties and features.

### SUMMARY OF THE INVENTION

The present invention relates to golf balls comprising a core having at least one layer; a composite layer that is disposed about the core; and a cover having at least one layer that is disposed about the composite layer. The composite and cover layers are formed from first and second substantially transparent polymeric matrices, respectively. At least one decorative insert member is sandwiched between the composite and cover layers. The decorative insert(s) is partially embedded in the composite and cover layers and is plainly visible to a human eye looking at the exterior of the ball. In one embodiment, the core is single-layered and made from a rubber composition. In another embodiment, the core has a dual-layered construction. Different polymers may be used to form the substantially transparent matrices, and these matrices also may contain various reflective fillers, pigments, dyes, and the like; provided, that the insert remains visible. In one embodiment, the cover is single-layered and made from an ionomer, polyurethane, or polyurea composition. In another embodiment, the cover includes inner and outer cover layers, each being substantially transparent.

The decorative insert is pre-formed prior to placing it the composite and cover layers and may be molded, machined, cast, laser-cut, or otherwise shaped into the desired geometries and dimensions. For example, the insert have a spherical or non-spherical shape such as a polygonal structure. Particular examples of decorative inserts include small figurines, charms, jewelry pieces, and other articles that provide an ornamental effect. In accordance with this invention, multiple decorative inserts of the same or different geometries and dimensions are sandwiched between the golf ball layers. The decorative inserts may be made from rubber, plastic, metal or other suitable materials and are sandwiched between the layers to provide unique aesthetics and an appealing appearance.

The invention also encompasses methods of producing a golf ball containing a decorative insert. In one preferred version, the method involves the steps of: forming an inner core; forming a secondary layer comprising a first substantially transparent polymeric matrix over the core and partially curing the layer; placing the decorative insert member in the partially-cured layer so that it is partially embedded; and forming a cover layer comprising a second substantially transparent polymeric matrix over the partially-cured layer. Portions of the decorative insert are enclosed in the first and second polymeric matrices. Then, the secondary and cover layers are cured to form a hardened ball containing the insert.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a top view of a golf ball having a dimpled cover and a visible decorative insert underlying the cover made in accordance with the present invention;

FIG. 2 is a cut-away view of a the golf ball shown in FIG. 1;

FIG. 3 is a cross-sectional view of a three-piece golf ball having an inner core; a composite layer, and an outer cover layer made in accordance with the present invention; and

FIG. 4 is a cross-sectional view of a four-piece golf ball having a dual-core comprising an inner core and outer core layer, a composite layer, and an outer cover layer made in accordance with the present invention.

### DETAILED DESCRIPTION OF THE INVENTION

The present invention relates generally to golf balls containing a core having at least one layer; a composite layer; and a cover having at least one layer. In one preferred embodiment, the composite layer comprises a first substantially transparent polymeric matrix and the cover comprises a second substantially transparent polymeric matrix. The decorative insert is “sandwiched” between the composite and cover layers so that one portion of the insert is embedded in the first transparent matrix, and a second portion of the insert is embedded in the second transparent matrix. The decorative insert, which is enclosed in the golf ball, is plainly visible to a human eye looking at the exterior of the ball. In an alternative version, the decorative insert is sandwiched between layers in the core structure. That is, one portion of the insert is embedded in the innermost core (center) of the ball and a second portion of the insert is embedded in the outer core layer. In this instance, the core layers as well as the surrounding outer layers comprise substantially transparent polymer matrices. In a further version, the decorative insert is positioned between substantially transparent cover layers. For example, the ball may include inner and outer cover layers and the insert may be placed between these layers to provide the cover structure with a special decorative effect. In this example, one portion of the insert is embedded in the inner cover layer and a second portion of the insert is embedded in the outer cover layer. Thus, there can be composite inner and/or outer cover layers, whereby the insert is enclosed in the cover and is relatively close to ball's surface. It also is recognized that the golf ball may contain multiple decorative inserts. For example, a plurality of decorative inserts may be placed between the composite and cover layers. The inserts may have various geometries and dimensions as described below. In another example, one decorative insert may be placed between the core layer and composite layer; while a second decorative insert may be placed between the composite layer and cover layer.

Golf balls having various constructions may be made in accordance with this invention. For example, golf balls having three-piece, four-piece, and five-piece constructions may be made. In one preferred embodiment, the balls include a core structure, a composite layer disposed about the core structure, and a surrounding cover structure. The composite layer comprises a first substantially transparent polymeric matrix and the cover comprises a second substantially transparent polymeric matrix. One portion of the insert is embedded in the first transparent matrix, and a second portion of the insert is embedded in the second transparent matrix. However, as discussed above, the decorative insert may be sandwiched between any adjacent layers in the golf ball so long as the insert is visible. The term, “layer” as used herein means generally any spherical portion of the golf ball. The term, “composite layer” as used herein means generally any layer containing at least a portion of the decorative insert embedded therein. Thus, if one portion of the insert is embedded in the inner core (center) and a second portion of the insert is embedded in the outer core layer, the core layers may be referred to as the inner and outer core composite layers, respectively. In another example, if one portion of the insert is embedded in the inner cover layer and a second portion of the insert is embedded in the outer cover layer, the cover layers may be referred to as the inner and outer cover composite layers, respectively. As noted above, the core may be single or multi-layered. In one version, the core has a dual-layered structure including an inner core (center) and surrounding outer core layer. In another version, the core has a multi-layered structure including a center, intermediate core layer, and outer core layer. The cover also may be single or multi-layered. In one version, the dual-cover includes inner cover and outer cover layers. Cover structures having three separate layers also may be made. In yet another construction, a five-piece golf ball having a dual-core, composite layer, and dual-cover is made. The golf balls also may include one or more intermediate layers disposed between the core and composite layers and/or disposed between the cover and composite layers. The diameter and thickness of the different layers along with properties such as hardness and compression may vary depending upon the construction and desired playing performance properties of the golf ball.

Core Structure

The golf ball may contain a single- or multi-layered core. In one preferred embodiment, at least one of the core layers is formed of a rubber composition comprising polybutadiene rubber material. More particularly, in one version, the ball contains a single inner core formed of the polybutadiene rubber composition. In a second version, the ball contains a dual-core comprising an inner core (center) and surrounding outer core layer. In yet another version, the golf ball contains a multi-layered core comprising an inner core, intermediate core layer, and outer core layer.

In one version, the inner core (or at least one core layer in a multi-layered core construction) is formed of a rubber composition comprising a rubber material such as, for example, polybutadiene, ethylene-propylene rubber, ethylene-propylene-diene rubber, polyisoprene, styrene-butadiene rubber, polyalkenamers, butyl rubber, halobutyl rubber, or polystyrene elastomers. In another version, the inner core (or at least one core layer in a multi-layered core construction) is formed from an ionomer composition comprising an ethylene acid copolymer containing acid groups such that greater than 70% of the acid groups are neutralized. For example, a multi-layered core comprising an inner core formed of a rubber composition; an intermediate core formed of the highly neutralized ionomer composition; and outer core layer formed of a rubber composition may be prepared. Such rubber and ionomer compositions are discussed in further detail below.

In one preferred embodiment, the cores in the golf balls of this invention have high-reflectance properties. Particularly, the core layer(s) may comprise light-reflective fillers to effectively scatter light rays that strike the outer surface of the core. For example, these light-reflective fillers may be selected from the group consisting of pearlescent pigments, glitter specks, metallics particularly metalized films and foils, and mixtures thereof as discussed in further detail below. The light-reflective fillers preferably comprise particles preferably have faces that have an individual reflectance of over 75%, more preferably at least 95%, and most preferably 99-100%. For example, flat particles with two opposite faces can be used. The particle size preferably is 0.1 mm-1.0 mm more preferably 0.2 mm-0.8 mm, and most preferably 0.25 mm-0.5 mm In general, an aesthetically pleasing reflective appearance can be obtained by using about 0.1-10, or more preferably 1-4 parts by weight reflective particles based on the weight of base rubber or other polymer in the composition. In other instances, the core layer may be coated with a highly reflective coating using vacuum-depositing techniques, spray, dipping, or other suitable techniques. For example, a reflective layer of vacuum-deposited aluminum or chrome, indium and the like may be formed. Such a layer preferably has a thickness of between about 0.0001 and about 0.0010 inches. The core composition may comprise white pigments such as, for example, zinc oxide, barium sulfate, titanium dioxide, calcium oxide, or the like to provide the core composition with high reflectance. Preferably, titanium dioxide is used as the white pigment. The white pigments reflect the light rays to provide a bright white opaque core. In this preferred version, the core is substantially reflective and enhances the appearance of the surrounding composite layer that contains the decorative insert as discussed further below.

In a second preferred embodiment, the core composition may contain colored pigments such as blue, green, red, or yellow pigments or the like. These colored pigments absorb most of the incident light as opposed to the white pigments that reflect most of the light. Such a colored core can provide color vibrancy and depth to the golf ball. The colored core material provides a richly colored background for the substantially transparent surrounding composite layer that contains the decorative insert as discussed further below.

In one preferred embodiment, the entire core or at least one core layer in a multi-layered structure is formed of a rubber composition comprising a material selected from the group of natural and synthetic rubbers including, but not limited to, polybutadiene, polyisoprene, ethylene propylene rubber (“EPR”), ethylene-propylene-diene (“EPDM”) rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

More preferably, the rubber composition comprises polybutadiene. In general, polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. Normally, a transition metal complex (for example, neodymium, nickel, or cobalt) or an alkyl metal such as alkyllithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. A preferred polybutadiene rubber has a 1,4 cis-bond content of at least 40%, preferably greater than 80%, and more preferably greater than 90%. In general, polybutadiene rubbers having a high 1,4 cis-bond content have high tensile strength. The polybutadiene rubber may have a relatively high or low Mooney viscosity.

Examples of commercially available polybutadiene rubbers that can be used in accordance with this invention, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh, Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; AFDENE 50 and NEODENE BR40, BR45, BR50 and BR60, available from Karbochem (PTY) Ltd. of Bruma, South Africa; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

The polybutadiene rubber preferably is used in an amount of at least about 5% by weight based on total weight of composition and is generally present in an amount of about 5% to about 100%, or an amount within a range having a lower limit of 5% or 10% or 20% or 30% or 40% or 50% and an upper limit of 55% or 60% or 70% or 80% or 90% or 95% or 100%. Preferably, the concentration of polybutadiene rubber is about 40 to about 95 weight percent. Lesser amounts of other thermoset materials may be incorporated into the base rubber. Such materials include the rubbers discussed above, for example, cis-polyisoprene, trans-polyisoprene, balata, polychloroprene, polynorbornene, polyoctenamer, polypentenamer, butyl rubber, EPR, EPDM, styrene-butadiene, and the like.

The rubber compositions of this invention may be cured using conventional curing processes. Suitable curing processes include, for example, peroxide-curing, sulfur-curing, high-energy radiation, and combinations thereof. Preferably, the rubber composition contains a free-radical initiator selected from organic peroxides, high energy radiation sources capable of generating free-radicals, and combinations thereof. In one preferred version, the rubber composition is peroxide-cured. Suitable organic peroxides include, but are not limited to, dicumyl peroxide; n-butyl-4,4-di(t-butylperoxy)valerate; 1,1-di(t-butylperoxy)3,3,5-trimethylcyclohexane; 2,5-dimethyl-2,5-di(t-butylperoxy)hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. In a particular embodiment, the free radical initiator is dicumyl peroxide, including, but not limited to Perkadox® BC, commercially available from Akzo Nobel. Peroxide free-radical initiators are generally present in the rubber composition in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubbers, and an upper limit of 2.5 parts or 3 parts or 5 parts or 6 parts or 10 parts or 15 parts by weight per 100 parts of the total rubber. Concentrations are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

The rubber compositions may further include a reactive cross-linking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particular examples of suitable metal salts include, but are not limited to, one or more metal salts of acrylates, diacrylates, methacrylates, and dimethacrylates, wherein the metal is selected from magnesium, calcium, zinc, aluminum, lithium, and nickel. In a particular embodiment, the co-agent is selected from zinc salts of acrylates, diacrylates, methacrylates, and dimethacrylates. In another particular embodiment, the agent is zinc diacrylate (ZDA). When the co-agent is zinc diacrylate and/or zinc dimethacrylate, the co-agent is typically included in the rubber composition in an amount within the range having a lower limit of 1 or 5 or 10 or 15 or 19 or 20 parts by weight per 100 parts of the total rubber, and an upper limit of 24 or 25 or 30 or 35 or 40 or 45 or 50 or 60 parts by weight per 100 parts of the base rubber.

Radical scavengers such as a halogenated organosulfur, organic disulfide, or inorganic disulfide compounds may be added to the rubber composition. These compounds also may function as “soft and fast agents.” As used herein, “soft and fast agent” means any compound or a blend thereof that is capable of making a core: 1) softer (having a lower compression) at a constant “coefficient of restitution” (COR); and/or 2) faster (having a higher COR at equal compression), when compared to a core equivalently prepared without a soft and fast agent. Preferred halogenated organosulfur compounds include, but are not limited to, pentachlorothiophenol (PCTP) and salts of PCTP such as zinc pentachlorothiophenol (ZnPCTP). Using PCTP and ZnPCTP in golf ball inner cores helps produce softer and faster inner cores. The PCTP and ZnPCTP compounds help increase the resiliency and the coefficient of restitution of the core. In a particular embodiment, the soft and fast agent is selected from ZnPCTP, PCTP, ditolyl disulfide, diphenyl disulfide, dixylyl disulfide, 2-nitroresorcinol, and combinations thereof.

In addition, the rubber compositions may include antioxidants to prevent the breakdown of the elastomers. Also, processing aids such as high molecular weight organic acids and salts thereof may be added to the composition. Suitable organic acids are aliphatic organic acids, aromatic organic acids, saturated mono-functional organic acids, unsaturated monofunctional organic acids, multi-unsaturated mono-functional organic acids, and dimerized derivatives thereof. Particular examples of suitable organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, and dimerized derivatives thereof. The organic acids are aliphatic, mono-functional (saturated, unsaturated, or multi-unsaturated) organic acids. Salts of these organic acids may also be employed. The salts of organic acids include the salts of barium, lithium, sodium, zinc, bismuth, chromium, cobalt, copper, potassium, strontium, titanium, tungsten, magnesium, cesium, iron, nickel, silver, aluminum, tin, or calcium, salts of fatty acids, particularly stearic, behenic, erucic, oleic, linoelic or dimerized derivatives thereof. It is preferred that the organic acids and salts of the present invention be relatively non-migratory (they do not bloom to the surface of the polymer under ambient temperatures) and non-volatile (they do not volatilize at temperatures required for melt-blending.)

Ethylene Acid Copolymers

In a second preferred embodiment, the entire core or at least one core layer in a multi-layered structure is formed of an ionomer composition comprising an ethylene acid copolymer containing acid groups that are at least partially neutralized. As discussed further below, preferably, the neutralization level is greater than 70%, more preferably at least 90% and even more preferably at least 100%. Suitable ethylene acid copolymers that may be used to form the compositions of this invention are generally referred to as copolymers of ethylene; C₃ to C₈ α,β-ethylenically unsaturated mono- or dicarboxylic acid; and optional softening monomer. Copolymers may include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like. The term, “copolymer,” as used herein, includes polymers having two types of monomers, those having three types of monomers, and those having more than three types of monomers. Preferred α,β-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth)acrylate” means methacrylate and/or acrylate.

When a softening monomer is included, such copolymers are referred to herein as E/X/Y-type copolymers, wherein E is ethylene; X is a C₃ to C₈ α,β-ethylenically unsaturated mono- or dicarboxylic acid; and Y is a softening monomer. The softening monomer is typically an alkyl (meth)acrylate, wherein the alkyl groups have from 1 to 8 carbon atoms. Preferred E/X/Y-type copolymers are those wherein X is (meth) acrylic acid and/or Y is selected from (meth)acrylate, n-butyl (meth)acrylate, isobutyl (meth)acrylate, methyl (meth)acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene in the acid copolymer is typically at least 15 wt. %, preferably at least 25 wt. %, more preferably least 40 wt. %, and even more preferably at least 60 wt. %, based on total weight of the copolymer. The amount of C₃ to C₈ α,β-ethylenically unsaturated mono- or dicarboxylic acid in the acid copolymer is typically from 1 wt. % to 35 wt. %, preferably from 5 wt. % to 30 wt. %, more preferably from 5 wt. % to 25 wt. %, and even more preferably from 10 wt. % to 20 wt. %, based on total weight of the copolymer. The amount of optional softening comonomer in the acid copolymer is typically from 0 wt. % to 50 wt. %, preferably from 5 wt. % to 40 wt. %, more preferably from 10 wt. % to 35 wt. %, and even more preferably from 20 wt. % to 30 wt. %, based on total weight of the copolymer. “Low acid” and “high acid” ionomeric polymers, as well as blends of such ionomers, may be used. In general, low acid ionomers are considered to be those containing 16 wt. % or less of acid moieties, whereas high acid ionomers are considered to be those containing greater than 16 wt. % of acid moieties.

The acidic groups in the copolymeric ionomers are partially or totally neutralized with a cation source. Suitable cation sources include metal cations and salts thereof, organic amine compounds, ammonium, and combinations thereof. Preferred cation sources are metal cations and salts thereof, wherein the metal is preferably lithium, sodium, potassium, magnesium, calcium, barium, lead, tin, zinc, aluminum, manganese, nickel, chromium, copper, or a combination thereof. The metal cation salts provide the cations capable of neutralizing (at varying levels) the carboxylic acids of the ethylene acid copolymer and fatty acids, if present, as discussed further below. These include, for example, the sulfate, carbonate, acetate, oxide, or hydroxide salts of lithium, sodium, potassium, magnesium, calcium, barium, lead, tin, zinc, aluminum, manganese, nickel, chromium, copper, or a combination thereof. Preferred metal cation salts are calcium and magnesium-based salts. High surface area cation particles such as micro and nano-scale cation particles are preferred. The amount of cation used in the composition is readily determined based on desired level of neutralization.

For example, ionomeric resins having acid groups that are neutralized from about 10 percent to about 100 percent may be used. In one ionomer composition, the acid groups are partially neutralized. That is, the neutralization level is from about 10% to about 70%, more preferably 20% to 60%, and most preferably 30 to 50%. These ionomer compositions, containing acid groups neutralized to 70% or less, may be referred to ionomers having relatively low neutralization levels.

On the other hand, the ionomer composition may contain acid groups that are highly or fully-neutralized. These highly neutralized polymers (HNPs) are preferred for forming at least one core layer in the present invention. In these HNPs, the neutralization level is greater than 70%, preferably at least 90% and even more preferably at least 100%. In another embodiment, an excess amount of neutralizing agent, that is, an amount greater than the stoichiometric amount needed to neutralize the acid groups, may be used. That is, the acid groups may be neutralized to 100% or greater, for example 110% or 120% or greater. In one preferred embodiment, a high acid ethylene acid copolymer containing about 19 to 20 wt. % methacrylic or acrylic acid is neutralized with zinc and sodium cations to a 95% neutralization level.

“Ionic plasticizers” such as organic acids or salts of organic acids, particularly fatty acids, may be added to the ionomer resin if needed. Such ionic plasticizers are used to make conventional ionomer composition more processable as described in Rajagopalan et al., U.S. Pat. No. 6,756,436, the disclosure of which is hereby incorporated by reference. In one preferred embodiment, the thermoplastic ionomer composition, containing acid groups neutralized to 70% or less, does not include a fatty acid or salt thereof, or any other ionic plasticizer. On the other hand, the thermoplastic ionomer composition, containing acid groups neutralized to greater than 70%, includes an ionic plasticizer, particularly a fatty acid or salt thereof. For example, the ionic plasticizer may be added in an amount of 0.5 to 10 pph, more preferably 1 to 5 pph. The organic acids may be aliphatic, mono- or multi-functional (saturated, unsaturated, or multi-unsaturated) organic acids. Salts of these organic acids may also be employed. Suitable fatty acid salts include, for example, metal stearates, laureates, oleates, palmitates, pelargonates, and the like. For example, fatty acid salts such as zinc stearate, calcium stearate, magnesium stearate, barium stearate, and the like can be used. The salts of fatty acids are generally fatty acids neutralized with metal ions. The metal cation salts provide the cations capable of neutralizing (at varying levels) the carboxylic acid groups of the fatty acids. Examples include the sulfate, carbonate, acetate and hydroxide salts of metals such as barium, lithium, sodium, zinc, bismuth, chromium, cobalt, copper, potassium, strontium, titanium, tungsten, magnesium, cesium, iron, nickel, silver, aluminum, tin, or calcium, and blends thereof. For example, the ionic plasticizer may be added in an amount of 0.5 to 10 pph, more preferably 1 to 5 pph. In addition to the fatty acids and salts of fatty acids discussed above, other suitable ionic plasticizers include, for example, polyethylene glycols, waxes, bis-stearamides, minerals, and phthalates. In another embodiment, an amine or pyridine compound is used, preferably in addition to a metal cation. Suitable examples include, for example, ethylamine, methylamine, diethylamine, tert-butylamine, dodecylamine, and the like. It is preferred the organic acids and salts be relatively non-migratory (they do not bloom to the surface of the polymer under ambient temperatures) and non-volatile (they do not volatilize at temperatures required for melt-blending).

Composite Layer

The golf balls of this invention further include a composite layer that preferably is disposed about the core structure. The composite layer comprises a first substantially transparent polymeric matrix. By the term, “substantially transparent” as used herein, it is meant a layer that is sufficiently clear for a person to see an underlying decorative insert member. The amount of light that passes through the first substantially transparent polymeric matrix may be measured so that the layer is considered optically transparent, semi-transparent, translucent, or the like. In each instance, however, the insert member lying in the composite layer must be plainly visible to the human eye. The above-described rubber and ionomer compositions may be used to form the polymeric matrix of the composite layer. Other suitable polymers that may be used to form the composite layer include, but are not limited to, the following polymers (including homopolymers, copolymers, and derivatives thereof.)

(a) polyesters, particularly those modified with a compatibilizing group such as sulfonate or phosphonate, including modified poly(ethylene terephthalate), modified poly(butylene terephthalate), modified polypropylene terephthalate), modified poly(trimethylene terephthalate), modified poly(ethylene naphthenate), and those disclosed in U.S. Pat. Nos. 6,353,050, 6,274,298, and 6,001,930, the entire disclosures of which are hereby incorporated herein by reference, and blends of two or more thereof;

(b) polyamides, polyamide-ethers, and polyamide-esters, and those disclosed in U.S. Pat. Nos. 6,187,864, 6,001,930, and 5,981,654, the entire disclosures of which are hereby incorporated herein by reference, and blends of two or more thereof;

(c) polyurethanes, polyureas, polyurethane-polyurea hybrids, and blends of two or more thereof;

(d) fluoropolymers, such as those disclosed in U.S. Pat. Nos. 5,691,066, 6,747,110 and 7,009,002, the entire disclosures of which are hereby incorporated herein by reference, and blends of two or more thereof;

(e) polystyrenes, such as poly(styrene-co-maleic anhydride), acrylonitrile-butadiene-styrene, poly(styrene sulfonate), polyethylene styrene, and blends of two or more thereof;

(f) polyvinyl chlorides and grafted polyvinyl chlorides, and blends of two or more thereof;

(g) polycarbonates, blends of polycarbonate/acrylonitrile-butadiene-styrene, blends of polycarbonate/polyurethane, blends of polycarbonate/polyester, and blends of two or more thereof;

(h) polyethers, such as polyarylene ethers, polyphenylene oxides, block copolymers of alkenyl aromatics with vinyl aromatics and polyamicesters, and blends of two or more thereof;

(i) polyimides, polyetherketones, polyamideimides, and blends of two or more thereof; and

(j) polycarbonate/polyester copolymers and blends.

As mentioned above, a decorative insert member is enclosed in the substantially transparent polymeric matrices comprising the composite and cover layers. One portion of the insert is embedded in the first polymeric matrix and a second portion is embedded in the second polymeric matrix. The insert is pre-formed prior to placing it the composite and cover layers and may be molded using any known molding technique such as injection, compression, or reaction injection molding. The insert also may be forged, machined, cast, die-cut, formed by stereo-lithography, laser-etched or cut, or otherwise formed using any known methods of creating 3-D objects. The decorative insert may be made from a metal, any plastic or polymeric material, composite or inorganic or hybrid organic-inorganic, or organo-metallic material. The insert shape may include virtually any 3-D object and may be spherical; any non-spherical shape including regular and irregular-shaped polygons, twisted ribbons, bows, or ties; or very complex shapes such as any living or inanimate object. The decorative insert may be any ornamental object that a customer could custom order. In this manner, the golf ball could be considered an article of functional jewelry comprising an insert in a shape of a figurine, charm, jewelry piece, or any other ornamental article that is desired by a customer. Insert shapes also include spheres, spheroids, or near spheres such as egg-shapes, any fraction of a sphere, facetted spheres or any facetted geometric shapes, pyramidal shapes, cubes, diamonds, cylindrical shapes, cone or truncated cones, torus, prisms, star or multi-armed shapes, any alpha-numeric figures or text, or combinations thereof. In the present invention, the inserts do not include fibrous materials or particles, that is, the inserts do not encompass continuous filaments, staple fiber, flock, chopped fiber, particulate, powders, granules, or any other fiber- or particle-like materials. The hardness and modulus of the insert may be the same as the polymeric matrix material, or be softer or harder and lower or higher in flex modulus than the matrix material. In one embodiment, the insert has a hardness of at least 5 Shore D greater than the hardness of the surrounding polymeric matrix and may have a hardness of at least 20 Shore D greater than hardness of the polymeric matrix. In one embodiment the insert is made of a metal material (for example, brass, bronze, stainless steel, copper, gold (plated), silver (plated), or the like) and the matrix is made of substantially clear ionomer (partially or fully-neutralized), polyurethane, or polyurea. In another embodiment, the insert is made of a cast acrylic (PMMA or MMA copolymer) and the matrix is made of substantially clear ionomer (partially or fully-neutralized), polyurethane, or polyurea. In still another version, the insert is made of diamond, artificial diamond, glass, or other inorganic material. In one example, the insert is made from pre-molded thermoset polyurethane spheres which are pigmented with a metallic and/or pearlescent pigment. The insert may be coated or treated with a material which improves the adhesion of the insert (if needed) to the surrounding polymeric matrix material, such as a chemical-coupling agent or adhesive (for example, epoxy, titanate, or silane) or treated with plasma, corona, or the like.

The size and volume of the insert(s) are limited only be the thickness and volume of the layer into which they are placed, but typically have a mean diameter of about 0.005 to 0.5 inches, preferably about 0.01 to 0.25 inches, more preferably about 0.05 to 0.150 inches and may be randomly placed or may be strategically placed in a pattern of relatively uniform separation or uniform overlapping. In one embodiment, the insert occupies from about 0.1 to about 60%, preferably about 1 to 50%, more preferably about 5 to 25% of the total volume of the composite layer. A single insert or a plurality of inserts may be placed in the composite layer. In general, the ball contains from one (1) to five-hundred (500) decorative insert members depending upon the geometries and dimensions of the inserts and the desired aesthetics. The geometries and dimensions of the various inserts may be identical or different. Preferably, the ball contains from 5 to 250 insert members, and most preferably from 25 to 100.

The United States Golf Association (“USGA”) has set total weight limits for golf balls. Particularly, the USGA has established a maximum weight of 45.93 g (1.62 ounces) for golf balls. Although the total weight of the golf ball is controlled, the distribution of weight within the ball can vary. Redistributing the weight or mass of the golf ball either toward the center of the ball or toward the outer surface of the ball changes its flight and spin characteristics, and these factors should be considered when incorporating the decorative insert into the composite layers of the golf balls of this invention. In one embodiment, the densities of the decorative insert and encapsulating polymeric matrices are substantially the same. That is, the decorative insert has a first density; the surrounding polymeric matrix (composite layer) has a second density; and the surrounding polymeric matrix (cover layer) has a third density, and these densities are approximately equivalent. In this manner, the ball has a balanced density and this helps minimize changes to the ball's flight and spin characteristics. The difference, if any, between the specific gravities of the insert and surrounding layer can be kept to a minimum by making these components with the same material. For example, the composite and cover layers and decorative insert could be made of the same rubber or plastic material. Preferably, the difference between the first density (decorative insert) and second/third densities (surrounding polymer matrices) is thirty percent or less, more preferably twenty percent or less, and most preferably ten percent or less. In this embodiment, where the components have nominally different densities, either the decorative insert or polymeric matrix may be of greater density. In another embodiment, the specific gravity of the decorative insert is substantially greater than the specific gravity of the surrounding polymeric matrices, but the insert is of such geometry and dimensions that there is no or minimal observable effect on the ball's flight and spin characteristics. In yet another embodiment, the specific gravity of the decorative insert is substantially greater than the specific gravity of the surrounding polymeric matrices, and multiple inserts are added to and uniformly distributed throughout the layer. The evenly distributed decorative inserts provide symmetry so there is no or minimal observable effect on the ball's flight and spin characteristics.

Preferably, the densities of the decorative insert that is inserted in the composite and cover layers and the surrounding polymeric matrices of the composite and cover layers are substantially the same. That is, the decorative insert has a first density; the surrounding polymeric matrix of the composite layer has a second density, and the surrounding polymeric matrix of the cover layer has a third density; and each these respective densities are preferably equivalent. In this manner, balanced densities in the composite and cover layers can be maintained and this helps minimize changes to the spin characteristics of the ball. Furthermore, it is important that the weight of the decorative insert be considered and the amount of fillers and other ingredients used in the polymeric matrices be adjusted, as needed, so the weight of the finished golf ball does not exceed limits set by the USGA. As noted above, for play outside of USGA competition, there is no maximum limit; thus, the golf balls can be constructed so they weigh more than 1.62 ounces. In addition, the USGA requires that golf balls used in competition have a diameter of at least 1.68 inches. There is no upper limit so many golf balls have an overall diameter falling within the range of about 1.68 to about 1.80 inches. In accordance with the present invention, the diameter and thickness of the core, composite, and cover layers may be adjusted, as needed, so that the ball meets USGA specifications of at least 1.68 inches in diameter.

The substantially transparent polymeric matrices are sufficiently free of light-reflective fillers, pigments, dyes, fluorescent materials, optical brighteners, glitter specks, metallics, and the like so that it can admit the necessary amount of light for making the insert member visible. In some instances, however, it may be desirable to include a relatively small amount of such additives in the polymeric matrices to enhance the decorative effect. For example, light reflective fillers including, but not limited to, pearlescent pigments, glitter specks, metallics particularly metalized films and foils, and mixtures thereof can be incorporated into the polymeric matrices; provided, the matrices remain clear enough to see the decorative insert.

It also should be understood that the decorative insert, by and in itself, may include these light-reflective fillers (for example, pearlescent pigments, glitter specks, color-flop pigments, edge-effect pigments, metallics, and mixtures thereof.) That is, the composition used to form the decorative insert may be filled with these light-reflective fillers or the surface of the insert may be coated with such fillers. These fillers can enhance the visibility and ornamental effect of the insert within the ball.

Pearlescent pigments are particularly preferred, because these materials can provide special luster effects. Pearlescent pigment is generally made up of multiple platelet-like semi-transparent particles. When light strikes the platelets, it is partially reflected and partially transmitted through them. There are many platelet surfaces in parallel orientation and many layers of pigment at different depths within the pearlescent pigment-containing paint, coating, or other composition. As light reflects off the platelet surfaces in the different layers, this creates a pearly luster effect. A person looking at the composition will see different reflections and scattering of light depending upon their viewing angle. Some pearlescent pigments do not have a layered structure, that is, they comprise discrete particles and do not contain coated substrates. For example, metal-effect pearlescent pigments such as aluminum, copper, copper-zinc (bronze) alloys, and zinc particles may be used. Basic lead carbonate and bismuth oxychloride pigment particles also can be used. Other pearlescent pigments have a layered structure, that is, they contain a substrate. For example, natural or synthetic mica platelets may be coated with iron oxide or titanium dioxide to form special effect pearlescent pigments. Organic pigments also can be crystallized to form pigment flakes and pigments having a natural pearlescence such as pigment suspensions derived from fish scales may be used.

Metallics, particularly metalized films and foils, and glitter specks, which comprise very small plastic pieces painted in metallic, neon, and iridescent colors to reflect light also can be used as reflective fillers in accordance with this invention. Any suitable metal, especially highly lustrous metals, may be used and these metallics can be in the form of flakes, particles, and the like. Metalized polyester films and aluminum foil are also highly reflective metallics that can be used in the various layers and decorative inserts of the golf ball.

Titanium dioxide pigment is preferably used as light-reflective filler, because of its light scattering properties including reflectivity and refraction. As the light strikes the surface of the composition, most of the light will be reflected because of the titanium dioxide pigment concentration. The light strikes the surface of the pigment (which has a relatively high refractive index in contrast to the binder resin), the light is bent and reflected outwardly. The portion of light which is not reflected will pass through the particles and will be bent in different direction. Other useful metal (or metal alloy) flakes, plates, powders, or particles may include bismuth boron, brass, bronze, cobalt, copper, nickel, chrome, iron, molybdenum, nickel powder, stainless steel, zirconium aluminum, tungsten metal, beryllium metal, zinc, or tin. Other metal oxides may include zinc oxide, iron oxide, aluminum oxide, magnesium oxide, zirconium oxide, and tungsten trioxide also may be suitable.

In other instances, the substantially transparent polymeric matrices may be lightly colored or tinted so long as the insert member remains visible. For example, a relatively small amount of colored pigments such as blue, green, red, or yellow pigments or the like may be blended in the polymeric matrices to impart some color to the composite and cover layers, but it is important that the insert member remains visible through these layers. Suitable pigments include nickel and chrome titanates, chrome yellow, cadmium types, carbon black, chrome oxide green types, phthalocyanine blue or green, perylene and quinacridone types, and other conventional pigments. Pigment extenders include, for example, barytes, heavy spar, microtalc, kaolin, micaceous iron oxide, magnesium mica, quartz flour, powdered slate, and silicon carbide. In a similar manner, the decorative insert, by and in itself, may be colored or tinted with these pigments to provide additional colored effects. Color-flop pigments, as disclosed in Ohira et al, U.S. Pat. Nos. 7,018,307 and 6,558,277, which show a change in color as the viewing angle changes may be used in accordance with the present invention. Edge-effect pigments, which are attracted to the edges or sharper contours of the surfaces to which they are applied, also may be used.

Likewise, if a fluorescent effect is desired, a relatively small amount of fluorescent dye may be added to the polymeric matrices so long as the insert member remains visible. Suitable fluorescent dyes include, for example, dyes from the thioxanthene, xanthene, perylene, perylene imide, coumarin, thioindigoid, naphthalimide and methine dye classes. Representative yellow fluorescent dye examples include, but are not limited to: Lumogen F Orange™ 240 (BASF, Rensselaer, N.Y.); Lumogen F Yellow™ 083 (BASF, Rensselaer, N.Y.); Hostasol Yellow™ 3G (Hoechst-Celanese, Somerville, N.J.); Oraset Yellow™ 8GF (Ciba-Geigy, Hawthorne, N.Y.); Fluorol 088™ (BASF, Rensselaer, N.Y.); Thermoplast F Yellow™ 084 (BASF, Rensselaer, N.Y.); Golden Yellow™ D-304 (DayGlo, Cleveland, Ohio); Mohawk Yellow™ D-299 (DayGlo, Cleveland, Ohio); Potomac Yellow™ D-838 (DayGlo, Cleveland, Ohio) and Polyfast Brilliant Red™ SB (Keystone, Chicago, Ill.) Conventional non-fluorescent dyes also may be used including, but not limited to, azo, heterocyclic azo, anthraquinone, benzodifuranone, polycyclic aromatic carbonyl, indigoid, polymethine, styryl, di- and tri-aryl carbonium, phthalocyanines, quinopphthalones, sulfur, nitro and nitroso, stilbene, and formazan dyes. The decorative insert also may be treated with these fluorescent dyes to provide the insert with a bright glow.

Optical brighteners, which typically emit a bluish light, also may be added to the compositions and/or decorative insert. In general, optical brighteners absorb the invisible ultra-violet portion of the daylight spectrum and convert this energy into the longer-wavelength visible portion of the spectrum. Suitable optical brighteners include, for example, stilbene derivatives, styryl derivatives of benzene and biphenyl, bis(benzazol-2-yl) derivatives, coumarins, carbostyrils, naphthalimides, derivatives of dibenzothiophene-5,5-dioxide, pyrene derivatives, and pyridotriazoles. In accordance with the present invention, any of these or other known optical brighteners including derivatives of 4,4′-diamino stilbene-2,2′-disulfonic acid, 4-methyl-7-diethylamino coumarin and 2,5-bis(5-tert-butyl)-2-benzoxazolyl)thiophene.

The decorative insert is partially embedded in the substantially transparent composite and cover layers in one preferred version. The golf ball further includes an underlying core structure and an overlying cover structure. This construction provides the ball with unique aesthetics. Particularly, in one preferred embodiment, the underlying core structure has an optically opaque appearance. More particularly, the composition used to form the core may have a high concentration of white pigment (for example, titanium dioxide) so the core has high reflectance. The white pigments reflect the light rays to provide a bright, white, opaque core. The incident light rays (except for a small amount that are absorbed by the polymer and/or pigment) that strike the surface of the core are reflected outwardly so the core appears opaque and white. At least a portion of these reflected light rays enter the surrounding composite layer containing the decorative insert. Some of the light entering the composite layer will strike the solid, embedded decorative insert and bounce off in multiple directions to provide an appealing appearance. In addition, light rays pass through the overlying cover material and enter the composite layer from different directions. As the light enters the composite layer from different directions and path lengths, it is scattered randomly to enhance the appearance of the composite layer and embedded decorative insert.

In a second preferred embodiment, the underlying core structure has an optically opaque appearance, because the composition used to form the core has a high concentration of colored pigments. The colored pigments provide opacity by absorbing the incident light at selective wavelengths. In general, the pigments only absorb certain light wavelengths of the visible spectrum (red, orange, yellow, green, and blue). The light frequencies, which are not absorbed, are transmitted back to give the appearance of a specific color. Thus, in colored cores, the incident light rays that strike the surface of the core are selectively absorbed so the core appears opaquely colored. Such a colored core can provide color vibrancy and depth to the substantially transparent surrounding composite layer. Thus, a person looking through the substantially transparent cover and composite layer can see the underlying insert against a richly colored background. Different colored cores and decorative inserts can be used to create different coloring effects. In another example, the substantially transparent cover layer can be lightly colored. The colored cover material, which lies above the composite layer, and the colored core, which lies beneath the composite layer, can provide the ball with aesthetically-pleasing colored highlights. The decorative insert is sandwiched between the substantially transparent composite and cover layers and scatters the colored light in different directions to produce unique visuals. In addition, reflective fillers and other ingredients can be added to the core and cover structures to provide the ball with a glossy, semi-glossy, or matte-like finished appearance. Another advantage of the present invention is that the decorative insert can be sandwiched between the composite and cover layers to provide a unique ornamental affect without sacrificing the playing performance properties of the ball such as resiliency and spin control.

The above-described golf ball assembly comprising a core, composite layer, and cover, wherein the composite layer comprises a first substantially transparent polymeric matrix and the cover comprises a second substantially transparent polymeric matrix and the decorative insert is sandwiched between the composite and cover layers so that one portion of the insert is embedded in the first transparent matrix, and a second portion of the insert is embedded in the second transparent matrix is one embodiment of the present invention and not meant to be restrictive. Other golf ball constructions can be made in accordance with this invention as noted above. For example, one portion of the decorative insert may be embedded in the innermost core (center) of the ball and a second portion of the insert is embedded in the outer core layer, wherein the center and outer core layer, as well as the surrounding outer layers, comprise substantially transparent polymer matrices. In another example, the ball may include inner and outer cover layers and the insert may be placed between these layers. Here, one portion of the insert is embedded in the substantially transparent inner cover layer and a second portion of the insert is embedded in the substantially transparent outer cover layer.

Cover Structure

The golf ball sub-assemblies (ball with core and composite layers) as discussed above, may be enclosed with a cover in accordance with this invention. The cover comprises a second substantially transparent polymeric matrix. The substantially transparent cover layer(s) may allow a measured amount of light to pass through so the layer(s) is characterized as being optically transparent, semi-transparent, translucent, or the like. In each instance, however, the insert member sandwiched between the composite and cover layers must be plainly visible to the human eye looking at the exterior of the ball. The above-described polymeric compositions used to form the composite layer may be used to form the polymeric matrix of the cover layer(s) in accordance with this invention. In a similar manner, the substantially transparent polymeric matrix comprising the cover layer(s) must be sufficiently free of light-reflective fillers, pigments, dyes, fluorescent materials, optical brighteners, glitter specks, metallics, and the like so that it can admit the light needed for making the underlying insert member visible. In some instances, however, it may be desirable to include a relatively small amount of such additives in the polymeric matrix of the cover layer(s) to enhance the overall aesthetics of the ball.

A wide variety of materials may be used for forming the second substantially transparent polymeric matrix of the cover including, for example, polyurethanes; polyureas; copolymers, blends and hybrids of polyurethane and polyurea; ethylene acid copolymer ionomer resins (for example, Surlyn® ionomer resins and HPF® 1000 and HPF® 2000, commercially available from DuPont; Iotek® ionomers, commercially available from ExxonMobil Chemical Company; Amplify® 10 ionomers of ethylene acrylic acid copolymers, commercially available from The Dow Chemical Company; and Clarix® ionomer resins, commercially available from A. Schulman Inc.); polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer and polyamide including, for example, Pebax® thermoplastic polyether block amides, commercially available from Arkema Inc; cross-linked trans-polyisoprene and blends thereof; polyester-based thermoplastic elastomers, such as Hytrel®, commercially available from DuPont; polyurethane-based thermoplastic elastomers, such as Elastollan®, commercially available from BASF; synthetic or natural vulcanized rubber; and combinations thereof. Castable polyurethanes, polyureas, and hybrids of polyurethanes-polyureas are particularly desirable because these materials can be used to help make a golf ball having high resiliency and a soft feel. By the term, “hybrids of polyurethane and polyurea,” it is meant to include copolymers and blends thereof.

Polyurethanes, polyureas, and blends, copolymers, and hybrids of polyurethane/polyurea are also particularly suitable for forming cover layers. When used as cover layer materials, polyurethanes and polyureas can be thermoset or thermoplastic. Thermoset materials can be formed into golf ball layers by conventional casting or reaction injection molding techniques. Thermoplastic materials can be formed into golf ball layers by conventional compression or injection molding techniques.

In one preferred embodiment, the ball includes a dual-cover comprising inner and outer cover layers, each of the layers being substantially transparent. The inner cover layer is preferably formed from a composition comprising an ionomer or a blend of two or more ionomers that helps impart hardness to the ball. The inner cover layer preferably has a material hardness of 95 Shore C or less, or less than 95 Shore C, or 92 Shore C or less, or 90 Shore C or less, or a material hardness within a range having a lower limit of 60 or 65 or 70 or 75 or 80 or 84 or 85 Shore C and an upper limit of 90 or 92 or 95 Shore C. The thickness of the inner cover layer is preferably within a range having a lower limit of 0.010 or 0.015 or 0.020 or 0.030 inches and an upper limit of 0.035 or 0.045 or 0.080 or 0.120 inches. The outer cover layer preferably has a material hardness of 85 Shore C or less. The thickness of the outer cover layer is preferably within a range having a lower limit of 0.010 or 0.015 or 0.025 inches and an upper limit of 0.035 or 0.040 or 0.055 or 0.080 inches. The outer cover layer preferably comprises a thermoplastic or thermosetting polyurethane, polyurea, or blend or hybrid of polyurethane/polyurea.

In a particular embodiment, the inner cover layer is formed from a composition comprising a high acid ionomer. A particularly suitable high acid ionomer is Surlyn 8150® (DuPont). Surlyn 8150® is a copolymer of ethylene and methacrylic acid, having an acid content of 19 wt %, which is 45% neutralized with sodium. In another particular embodiment, the inner cover layer is formed from a composition comprising a high acid ionomer and a maleic anhydride-grafted non-ionomeric polymer. A particularly suitable maleic anhydride-grafted polymer is Fusabond 525D® (DuPont), which is a maleic anhydride-grafted, metallocene-catalyzed ethylene-butene copolymer having about 0.9 wt % maleic anhydride grafted onto the copolymer. A particularly preferred blend of high acid ionomer and maleic anhydride-grafted polymer is a 84 wt %/16 wt % blend of Surlyn 8150® and Fusabond 525D®. Blends of high acid ionomers with maleic anhydride-grafted polymers are further disclosed, for example, in U.S. Pat. Nos. 6,992,135 and 6,677,401, the entire disclosures of which are hereby incorporated herein by reference. In another embodiment, the outer cover layer comprises an ionomer and inner cover layer comprises a thermoplastic or thermosetting polyurethane, polyurea, or blend or hybrid of polyurethane/polyurea. In this embodiment, both cover layers are relatively thin (thickness of about 0.010 to about 0.040 inches) and the Shore D hardness of the ionomer outer layer is greater than the Shore D hardness of the polyurethane inner cover layer.

As discussed above, the golf ball sub-assembly may be enclosed with a single-layered or multi-layered covers. In one embodiment, a single-layered cover having a thickness in the range of about 0.015 to about 0.090 inches, more preferably about 0.030 to about 0.070 inches, is formed. The cover has a hardness of about Shore D 80 or less, more preferably 70 or less, and most preferably about 60 or less. In another embodiment, a multi-layered cover comprising inner and outer cover layers is formed, where the inner cover layer has a thickness of about 0.01 inches to about 0.06 inches, more preferably about 0.015 inches to about 0.040 inches, and most preferably about 0.02 inches to about 0.035 inches. In this version, the inner cover layer is formed from a partially- or fully-neutralized ionomer having a Shore D hardness of greater than about 55, more preferably greater than about 60, and most preferably greater than about 65. The outer cover layer, in this embodiment, preferably has a thickness of about 0.015 inches to about 0.055 inches, more preferably about 0.02 inches to about 0.04 inches, and most preferably about 0.025 inches to about 0.035 inches, with a hardness of about Shore D 80 or less, more preferably 70 or less, and most preferably about 60 or less. The inner cover layer is harder than the outer cover layer in this version. A preferred outer cover layer is a castable or reaction injection molded polyurethane, polyurea or copolymer, blend, or hybrid thereof having a Shore D hardness of about 40 to about 50. In another multi-layer cover, dual-core embodiment, the outer cover and inner cover layer materials and thickness are the same but, the hardness range is reversed, that is, the outer cover layer is harder than the inner cover layer.

Manufacturing of Golf Ball Components

The core and cover compositions may be prepared using conventional mixing techniques. The core composition can be formed into an inner core structure by ordinary techniques such as, for example, injection or compression molding the composition. Injection molding, compression molding, or other conventional methods can be used to form additional core layer(s) for a multi-layered core structure. The composite layer is subsequently molded over the core structure to produce an intermediate ball (sub-assembly). More particularly, in compression molding, the polymer composition for the composite layer is formed into smooth surfaced hemispherical shells which are then positioned around the core structure in a mold having the desired thickness and subjected to molding under heat followed by cooling. This process fuses the shells together to form a unitary intermediate ball (sub-assembly). Alternatively, the intermediate balls may be produced by injection molding, wherein the composite layer composition is injected directly around the core placed at the center of the ball mold under heat and pressure.

In the present invention, the decorative insert is pressed into the partially-cured layer so that it is partially embedded therein. Under ordinary circumstances, it would be difficult to press the insert into the composite layer. However, because the composite layer is only partially-cured at this point, the insert can be placed easily in the layer and properly oriented. It is easy to work move the insert in the layer and the position of the insert can be adjusted as needed. The partially-cured layer is not fully hard at this point. Rather, the partially hardened material is in a highly moldable condition. The material has a generally soft, wax-like consistency. Still, the partially-cured layer has sufficient hardness and stability such that the insert is not easily moved out of position. In this invention, it is preferable that the insert be only partially encapsulated by the first polymer matrix. That is, the insert is partly enclosed by the composite layer and partly enclosed by the surrounding cover layer. The polymer composition used to form the cover may be molded over the intermediate ball using known techniques such as injection molding, compression molding, reaction injection molding, and casting. One portion of the insert is embedded in the first polymeric matrix and a second portion of the insert member is embedded in the second polymeric matrix. A portion of the insert member protrudes into the surrounding cover layer. The insert member is sandwiched between the substantially transparent composite and cover layers. After the insert has been placed in the desired location, the composite and cover layers are fully-cured. This helps the embedded insert to mechanically bond strongly to the encapsulating polymeric matrices of the composite and cover layers. In addition, the surface of the insert may be treated with silane-coupling agents, corona discharge, sand blasting, or the like to improve adhesion of the insert to the surrounding polymeric matrices. After molding, the golf balls produced may undergo various further processing steps such as marking, coating, and polishing to produce a finished ball.

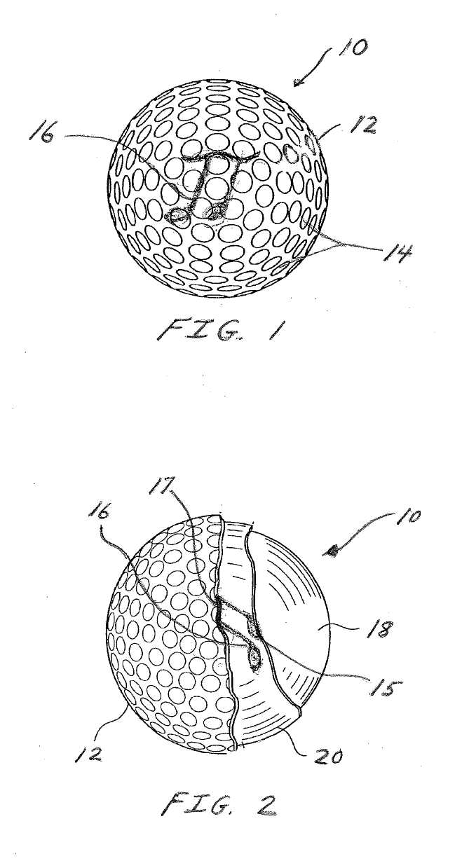

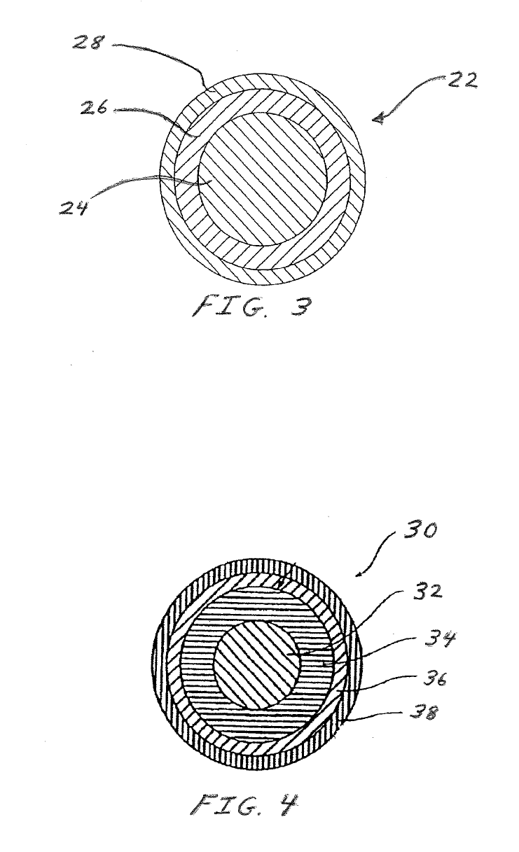

Referring to FIG. 1, a front view of a finished golf ball that can be made in accordance with this invention is generally indicated at (10). The ball (10) includes a substantially transparent cover (12) having a dimpled surface (14). The dimples (14) may have various shapes and be arranged in various patterns to modify the aerodynamic properties of the ball as is known in the art. The ball includes a decorative insert member (16) that is visible through the substantially transparent cover (12). (In this version, the decorative insert (16) is in the shape of a pair of hockey sticks.) In FIG. 2, a cut-away view of the ball (10) in FIG. 1 is shown. The ball (10) includes a solid inner core (18) that is opaque, and a composite layer (20) and single-layered cover (12) that are both substantially transparent. The decorative insert (16) is partially embedded in the composite layer (20) and partially embedded in the cover (12). One portion (15) of the decorative insert (16) protrudes into the composite layer (20) and another portion (17) protrudes into the cover layer (12). Since the composite and cover layers (20, 12) are both substantially transparent, the insert (16) is plainly visible from the exterior of the ball (10). FIG. 3 shows a side cross-sectional view of a three-piece golf ball (22) of this invention. The ball (22) contains a core (24), composite layer (26), and cover layer (28). In FIG. 3, the enclosed decorative insert (16) (not shown in this cross-sectional view) is sandwiched between the substantially transparent composite and cover layers (26, 28). In FIG. 4, a side cross-sectional view of a four-piece ball (30) of this invention is shown. The ball includes an inner core (center) (32) and outer core layer (34); composite inner cover layer (36); and composite outer cover layer (38). The enclosed decorative insert (16) (not shown in this cross-sectional view) is positioned between the substantially transparent inner and outer cover layers (36, 38). It should be understood the golf balls shown in FIGS. 1-4 are for illustrative purposes only and not meant to be restrictive. Other golf ball constructions can be made in accordance with this invention.

For example, the golf ball may be a five-piece ball having an inner core (center), outer core layer, a composite layer with an embedded decorative insert, inner cover layer, and surrounding outer cover layer. In another version, the golf ball may have a multi-layered core construction comprising an inner core, intermediate core layer, and outer core layer. The composite layer containing the embedded decorative insert may surround the multi-layered core structure, and an outer cover layer may be disposed about the composite layer.

In a multi-layered core construction, the center preferably has a diameter within a range having a lower limit of 0.100 or 0.125 or 0.250 inches or 0.300 and an upper limit of 0.375 or 0.400 or 0.500 or 0.750 or 1.00 or 1.25 or 1.40 or 1.60 inches. More preferably, the center has a diameter within a range of about 0.25 to about 1.40 inches. The intermediate core layer preferably has a thickness within a range having a lower limit of 0.050 or 0.100 or 0.150 or 0.200 inches and an upper limit of 0.300 or 0.350 or 0.400 or 0.500 inches. The outer core layer encloses the center and intermediate core layers such that the multi-layer core has an overall diameter within a range having a lower limit of 1.40 or 1.45 or 1.50 or 1.55 inches and an upper limit of 1.58 or 1.60 or 1.62 or 1.66 inches.

In this multi-layered core construction, the center preferably has an outer surface hardness of 70 Shore C or greater, more preferably a surface hardness of 80 Shore C or greater, and most preferably a surface hardness of 85 Shore C or greater. For example, the center may have an outer surface hardness within a range having a lower limit of 70 or 75 or 80 Shore C and an upper limit of 90 or 95 Shore C. The outer core layer preferably has an outer surface hardness that is less than that of the center and is preferably 50 Shore C or less; or 60 Shore C or less; or 70 Shore C or less; or 75 Shore C or less; or 80 Shore C or less. The intermediate layer preferably has an inner surface hardness greater than that of the center and outer core layer hardness values. Preferably, the intermediate layer has a surface hardness of 80 Shore C or greater.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

All patents, publications, test procedures, and other references cited herein, including priority documents, are fully incorporated by reference to the extent such disclosure is not inconsistent with this invention and for all jurisdictions in which such incorporation is permitted.

It is understood that the compositions and golf ball products described and illustrated herein represent only some embodiments of the invention. It is appreciated by those skilled in the art that various changes and additions can be made to compositions and products without departing from the spirit and scope of this invention. It is intended that all such embodiments be covered by the appended claims.

1. A golf ball, comprising a core having at least one layer;
a composite layer disposed about the core; the composite layer comprising a first substantially transparent polymeric matrix; and
a cover having at least one layer, the cover being disposed about the composite layer and comprising a second substantially transparent polymeric matrix, wherein one portion of a decorative insert member is embedded in the first polymeric matrix and a second portion of the insert member is embedded in the second polymeric matrix so that the decorative insert is visible from the exterior of the ball.

2. The golf ball of claim 1, wherein the core is single-layered, the core being formed from a rubber composition.

3. The golf ball of claim 1, wherein the core is dual-layered, the core comprising an inner core and surrounding outer core layer, at least one of the core layers being formed from a rubber composition.

4. The golf ball of claim 1, wherein the core comprises a reflective material.

5. The golf ball of claim 4, wherein the reflective material is white pigment.

6. The golf ball of claim 1, wherein the insert member is a metal material.

7. The golf ball of claim 1, wherein the insert member is a plastic material.

8. The golf ball of claim 1, wherein the insert member has a spherical shape.

9. The golf ball of claim 1, wherein the insert member has a non-spherical shape.

10. The golf ball of claim 1, wherein the first substantially transparent polymer matrix comprises a polymer selected from the group consisting of: ethylene acid copolymer ionomers; polyesters; polyamides; polyurethanes, polyureas; fluoropolymers; polystyrenes; polypropylenes, polyethylenes; polyvinyl chlorides; polyvinyl acetates; polycarbonates; polyvinyl alcohols; polyethers; polyimides, polyetherketones, polyamideimides; and mixtures thereof.

11. The golf ball of claim 1, wherein the decorative insert member comprises a reflective material.

12. The golf ball of claim 1, wherein the decorative insert member comprises light-reflective fillers selected from the group consisting of pearlescent pigments, glitter, metalized films and foils, and mixtures thereof.

13. The golf ball of claim 12, wherein the light-reflective fillers are pearlescent pigments selected from the group consisting of metalized pigments, mica-based pigments, borosilicate pigments, titanium dioxide pigments, iron oxide pigments, and mixtures thereof.

14. The golf ball of claim 1, wherein the decorative insert member comprises a colorant selected from dyes, pigments, and mixtures thereof.

15. The golf ball of claim 1, wherein the cover is a single layer having a thickness of about 0.015 to about 0.090 inches.

16. The golf ball of claim 1, wherein the cover comprises two or more layers and has an overall thickness of about 0.020 to about 0.210 inches.

17. The golf ball of claim 16, wherein the cover comprises an inner cover layer formed of an ionomer resin comprising an ethylene acid copolymer and an outer cover layer formed of a polyurethane composition, each of the cover layers being substantially transparent.

18. The golf ball of claim 1, wherein the second substantially transparent polymeric matrix comprises a polymer selected from the group consisting of: ethylene acid copolymer ionomers; polyesters; polyamides; polyurethanes, polyureas; fluoropolymers; polystyrenes; polypropylenes and polyethylenes; polyvinyl chlorides; polyvinyl acetates; polycarbonates; polyvinyl alcohols; polyethers; polyimides, polyetherketones, polyamideimides; and mixtures thereof.

19. The golf ball of claim 1, wherein the second substantially transparent polymeric matrix comprises light-reflective fillers selected from the group consisting of pearlescent pigments, glitter specks, metalized films and foils, and mixtures thereof.

20. The golf ball of claim 19, wherein the light-reflective fillers are pearlescent pigments selected from the group consisting of metalized pigments, mica-based pigments, borosilicate pigments, titanium dioxide pigments, iron oxide pigments, and mixtures thereof.

21. The golf ball of claim 1, wherein the second substantially transparent polymeric matrix comprises a colorant selected from dyes, pigments, and mixtures thereof.

22. The golf ball of claim 17, wherein the colorant is a fluorescent dye.

23. A method of producing a golf ball containing a decorative insert, comprising the steps of:
forming an inner core;
forming a secondary layer comprising a first substantially transparent polymeric matrix over the core and partially curing the layer;
placing an insert member in the partially-cured layer so that one portion of an insert member is embedded in the first substantially transparent polymeric matrix;
forming a cover layer comprising a second substantially transparent polymeric matrix over the partially cured layer so that a second portion of the insert member is embedded in the second substantially transparent polymeric matrix; and curing the secondary and cover layers to form a hardened golf ball containing a decorative insert that is visible from the exterior of the ball.

24. The method of claim 23, wherein the core is single-layered, the core being formed from a rubber composition.

25. The method of claim 23, wherein the core is dual-layered, the core comprising an inner core and surrounding outer core layer, at least one of the core layers being formed from a rubber composition.

26. The method of claim 23, wherein the insert member is a metal material.

27. The method of claim 23, wherein the insert member is a plastic material.

28. The method of claim 23, wherein the decorative insert member comprises a reflective material.

29. The method of claim 23, wherein the cover is a single layer having a thickness of about 0.015 to about 0.090 inches.

30. The method of claim 23, wherein the cover comprises two or more layers and has an overall thickness of about 0.020 to about 0.210 inches.
